(19) United States
(12) Patent Application Publication
(10) Pub. No.: US 2004/0021271 A1
(43) Pub. Date: Feb. 5, 2004

(54) Retaining ring and cover plate for fuel unit

(76) Inventor: Michael Tratnik, Mississauga (CA)

Correspondence Address: Robin W Asher, Clark Hill, 500 Woodward Avenue Suite 3500, Detroit, MI, 48226-3435, US

(21) Appl. No.: 10/415,390

(22) PCT Filed: Oct. 26, 2001
(86) PCT No.: PCT/CA01/01501

(51) Int. Cl. F02M 37/10

(52) U.S. Cl. 277/616

(57) ABSTRACT

A fuel sealing assembly seals a fuel sender unit to a fuel tank. The fuel sealing assembly includes a retainer having a locking finger and a plurality of retaining lugs, and cover plate having a detent and a plurality of slots. Each of the plurality of slots receives one of the plurality of retaining lugs. The cover plate is rotated relative to the retainer so that the retaining lugs abut the to circumferential surface of the cover plate. The detent then receives the locking finger to lock the cover plate to the retainer. As a result. Both axial and rotational movement of the fuel sender unit is prevented.

### BACKGROUND OF THE INVENTION

1. Field of the Invention

The invention relates to a fuel sender unit of a vehicle. More particularly, the invention is directed to a fuel sealing assembly for sealing the fuel sender unit to a fuel tank.

2. Description of the Related Art

A fuel sender unit is an apparatus within a vehicle fuel tank. The fuel sender unit includes an electric fuel pump and a reservoir for accumulating a reserve supply of fuel. This reserve supply of fuel is used by the fuel pump when the fuel pump is temporarily starved for fuel, such as when a vehicle executes a turn with a near empty fuel tank.

The fuel sender unit must be tightly sealed to the fuel tank so that the fuel sender unit will not leak liquid or fuel vapor. At the same time, the fuel sender unit must be accessible for periodic servicing.

Conventional fuel sending systems typically employ a retainer ring to secure a fuel sender assembly to a fuel tank assembly. The fuel tank assembly includes a fuel tank having a circular aperture through which a lower portion of the fuel sender assembly extends. The fuel tank has a planar external surface that is generally perpendicular to the axis of the aperture. An annular groove is provided within the external surface which is concentric with the central axis of the aperture and which is located radially outward thereof.

The fuel tank also includes a plurality of evenly spaced retaining lugs located radially outward of, and concentric with, the annular groove. The retaining lugs are disposed around the circumference of the annular groove and have a first leg extending transversely to the planar external surface of the fuel tank. A second leg is provided which extends radially inwardly from the first leg and is generally parallel to the planar external surface, so as to generally define an inverted “L-shaped” configuration for the retainer lugs.

The retainer ring is provided with a central aperture through which an upper portion of the fuel sender assembly passes. The retainer ring has an axially extending rim that surrounds the upper portion of the fuel sender assembly. At a peripheral edge, the retainer ring is provided with a plurality of radially outwardly extending lug supports. The number and angular spacing of the lug supports corresponds directly to the number and angular spacing of the retainer lugs. The lug supports are received into an “L-shaped” retainer lug upon rotation of the retainer ring into a locked position. The lug supports have an upstanding tab stop at one end. The tab stops have a greater height than the first leg of the retainer lug so as to positively locate each of the tabs relative to the retainer lugs during clockwise rotation of the retainer ring into a locked position. Further, the tabs are provided with a centralized upwardly extending retainer nub configured to be received in a similarly shaped cavity provided in the second leg of the retainer lugs.

In practice, the engagement of the retainer nubs in the cavities, combined with the abutting contact of the tab stops with a circumferential edge of the second leg, act to sealingly lock the fuel sender assembly to the fuel tank. Further, the seal member placed in the annular groove is compressed by the locking relationship of the above-described components to generate a fluid-tight seal therebetween so as to prevent unintended leakage of fuel liquid or vapor.

During vehicular accidents in which the fuel tank is dented or otherwise deformed, high pressure is generated within the fuel tank which causes a sender plate of the fuel sender unit and the retainer ring to deform in a concave fashion. Such defonnation plastically deforms the retainer lugs in a radially outward direction such that the seal becomes improperly seated within the annular groove. As such, premature and excessive leakage of fuel from the fuel tank occurs.

Accordingly, it is desirable to provide a relatively simple and inexpensive design for an improved retainer for sealing the fuel sender unit to the fuel tank.

### SUMMARY OF THE INVENTION

A fuel sealing assembly is provided for sealing a fuel sender unit to a fuel tank. The fuel sealing assembly includes a retainer fixedly secured to the fuel tank. The retainer provides a sealing surface between the fuel sender unit and the fuel tank. The retainer has a peripheral edge, and includes a locking finger and a plurality of retaining lugs extending out from the peripheral edge. The fuel sealing assembly also includes a cover plate positionable over the retainer and the fuel sender unit. The cover plate defines a circumferential top surface having a plurality of slots extending therethrough and a detent. Each of the plurality of slots receives one of the plurality of retaining lugs therein and the detent receives the locking finger thereagainst locking the cover plate over the retainer. As a result, both axial and rotational movement of the fuel sender unit is prevented.

In addition, the invention is directed to a method for manufacturing a fuel sealing assembly including a retainer having a locking finger and a plurality of retaining lugs and a cover plate, having a plurality of slots and a detent, for sealing a fuel sender unit with a fuel tank. The method includes the steps of inserting a seal member between the retainer and the fuel sender unit, aligning the cover plate with the retainer so that each of the plurality of slots of the cover plate is aligned with one of the plurality of retaining lugs of the retainer, abutting the cover plate to the retainer so that each of the retaining lugs extends through one of the plurality of slots, rotating the cover plate relative to the retainer and the fuel sender unit, and locking the retainer to the cover plate. The locking step may be achieved by forcing the locking finger into the detent.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a retainer;

FIG. 2 is a perspective view of the retainer with a seal member;

FIG. 3 is a perspective view of a fuel sender unit and the retainer;

FIG. 4 is a cross-sectional view, partially cut away, taken along lines 4-4 of FIG. 3; and

FIG. 5 is a perspective view of a cover plate, the fuel sender unit and the retainer.

### DETAILED DESCRIPTION OF THE PREFERRED EMBODIMENT

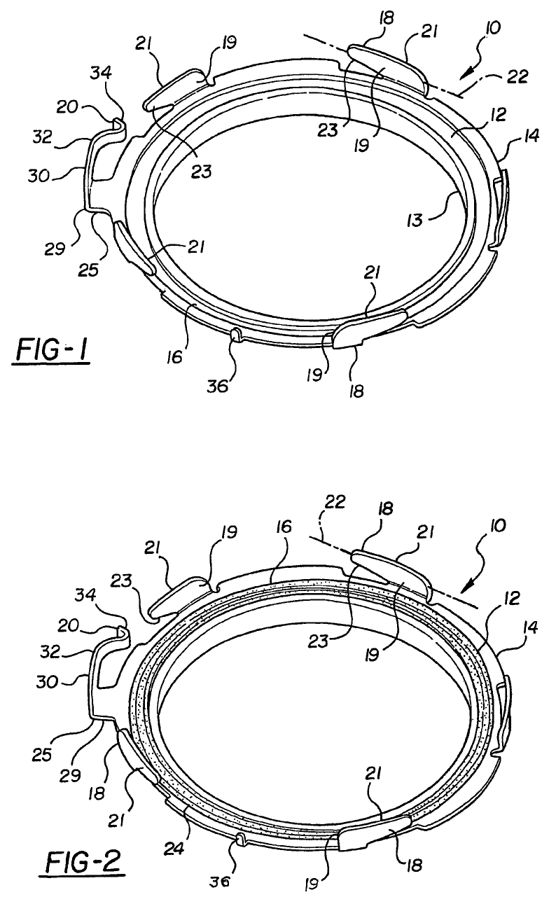

Referring to FIG. 1, a retainer is generally indicated at 10. The retainer 10 is shown as being ring-shaped extending between an inner surface 13 and a peripheral edge 14. The retainer 10 may, however, be made in various shapes. In addition, the retainer 10 has an upper surface 12. The upper surface 12 defines an annular groove 16. A plurality of retaining lugs 18 is disposed along the peripheral edge 14.

A plurality of retaining lugs 18 extend out from the peripheral edge 14. Each retaining lug 18 is L-shaped. A short leg 19 of the L-shaped retaining lug 18 extends upwardly perpendicular to the upper surface 12, whereas a long leg 21 of the L-shaped retaining lug 18 defines a longitudinal axis 22 that runs parallel to the upper surface 12. The long leg 21 includes an angled surface 23 that is spaced apart from the upper surface 12.

The retainer 10 also includes a locking finger 20. The locking finger 20 includes a base 25 having first 29 and second 30 base portions. The first base portion 29 extends radially out from the peripheral edge 14. The second base portion 30 extends out from the first base portion 29 perpendicularly thereto.

The locking finger 20 includes a finger 32 that extends out from the second base portion 30 in a direction tangential to peripheral edge 14. A locking end 34 is disposed at the distal end of the finger 32. Therefore, the finger 32 is disposed above and extends parallel to the upper surface 12 of the retainer 10.

The retainer 10 further includes a tab 36 that extends upwardly from the peripheral edge 14. The tab 36 is used to orient other elements, discussed subsequently, with the retainer 10.

Although the plurality of retaining lugs 18 are shown on the peripheral edge 14 of the retainer 10, it is recognized that the retaining lugs 18 may be located at a position other than the peripheral edge 14. For example, the retaining lugs 18 may be located at any point along the upper surface 12 of the retainer 10.

Referring to FIG. 2, the retainer 10 is shown with a seal member 24 inserted into the annular groove 16. The seal member 24 is a conventional rubber seal. The annular groove 16 prevents the seal member 24 from having an irregular sealing interface with a fuel sender unit 26, discussed subsequently. However, it is contemplated that the sealing required between the retainer 10 and the fuel sender unit 26 may be achieved by varying methods. For example, in another embodiment of the invention, the seal member 24 may be a nylon gasket and the like.

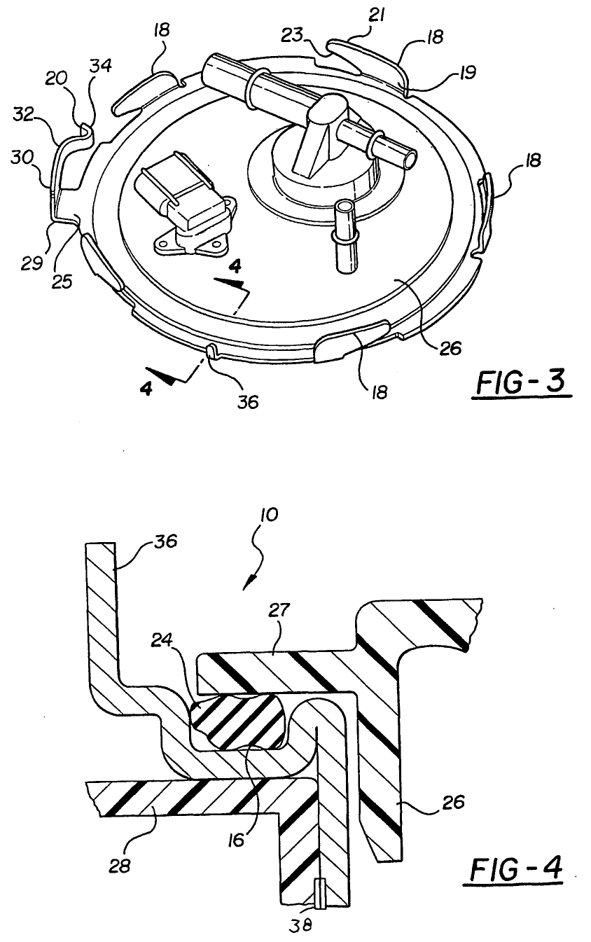

Referring now to FIG. 3, the fuel sender unit 26 is shown positioned over the retainer 10 (which is not shown except for the retaining lugs 18, the locking finger 20, and the tab 36). The tab 36 abuts the fuel sender unit 26 to align the fuel sender unit 26 with the retainer 10. It should be appreciated by those skilled in the art that, in an alternative embodiment, the retainer 10 may be integrally formed with the fuel sender unit 26. In this instance, the seal member 24 would not be required due to the unitary structure.

The relationship between the retainer 10, the seal member 24, a fuel sender unit 26, and a fuel tank 28 is seen in further detail in FIG. 4. The seal member 24 is seated within the annular groove 16 of the retainer 10, and is depicted in an uncompressed state. An outward flange portion 27 of the fuel sender unit 26 is positioned at least partially above the seal member 24 to compress the seal member 24. The flange portion 27 positively engages the retainer 10. The seal member 24 is an “H” seal, but other types of seals, including a round seal and a lathe cut seal, may be used.

Preferably, the retainer 10 is fabricated from relatively thin (1-5 mm) gage stainless steel. The fuel tank 28 is also preferably fabricated from stainless steel so that the retainer 10 and the fuel tank 28 can be welded or otherwise bonded to each other with a fastening agent 38. Together with a cover plate 40, this bonding maintains the fuel sender unit 26 in sealed relationship with the fuel tank 28 under substantially high fuel tank pressures so as to inhibit premature leakage of fuel.

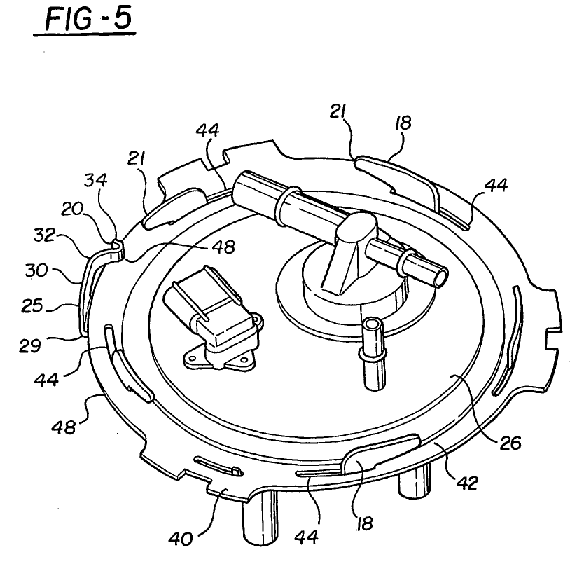

Referring now to FIG. 5, the cover plate 40 is shown positioned above the retainer 10 (which is not shown except for the retaining lugs 18 and the locking finger 20) and the fuel sender unit 26. The cover plate 40 has a circumferential top surface 42 and a plurality of slots 44 extending therethrough. Each of the plurality of slots 44 receives one of the plurality of retaining lugs 18 therethrough. After each of the plurality of retaining lugs 18 are positioned within one of the plurality of slots 44, the cover plate 40 is rotated relative to the retainer 10 and the fuel sender unit 26 until the angled surface 23 of each of the retaining lugs 18 engages the top circumferential surface 42 of the cover plate 40. The angled surface 23 then provides a guide for moving, with continued rotation, the fuel sender unit 26 into sealing engagement with the retainer 10.

After engagement of the retaining lugs 18 with the top circumferential surface 42 of the cover plate 40, the retainer 10 is locked to the cover plate 40. A detent 46 is located on an outer edge 48 of the cover plate 40. The detent 46 receives the locking end 34 of the finger 32 after rotation of the cover plate 40 relative to the retainer 10 and the fuel sender unit 26 to lock the cover plate 40 to the retainer 10. Removal of the locking end 34 from the detent 46 can only occur after friction and spring forces are overcome. As a result, rotational movement of the fuel sender unit is constrained.

Upon completion of the mounting of the cover plate 40 over the retainer 10 and the fuel sender unit 26, the retainer 10 is welded or otherwise bonded to the metallic steel fuel tank using well-known techniques.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

What is claimed is:

1. A fuel sealing assembly for sealing a fuel sender unit to a fuel tank, said fuel sealing assembly comprising:
a retainer fixedly secured to the fuel tank and providing a sealing surface between the fuel sender unit and the fuel tank, said retainer having a peripheral edge, said retainer including a locking finger extending out from said peripheral edge; and
a cover plate positionable over said retainer and the fuel sender unit for securing the fuel sender unit to said retainer, said cover plate defining a circumferential top surface having a plurality of slots extending therethrough and a detent, wherein said detent receives said locking finger thereagainst locking the cover plate over said retainer.

2. A fuel sealing assembly as set forth in claim 1 including a plurality of retaining lugs disposed on said peripheral edge of said retainer, each of said plurality of retaining lugs received by one of said plurality of slots.

3. A fuel sealing assembly as set forth in claim 2 wherein each of said plurality of retaining lugs engages said circumferential top surface of said cover plate preventing axial movement of said retainer and the fuel sender unit.

4. A fuel sealing assembly as set forth in claim 3 wherein said cover plate includes an outer edge and said detent extends into said outer edge.

5. A fuel sealing assembly as set forth in claim 4 wherein said retainer defines an annular groove.

6. A fuel sealing assembly as set forth in claim 5 including a seal member inserted within said annular groove of said retainer ring for sealing the fuel sender unit to said retainer ring.

7. A fuel sealing assembly as set forth in claim 6 wherein said peripheral edge of said retainer includes a tab extending radially out therefrom for aligning the fuel sender unit with said retainer.

8. A fuel sealing assembly as set forth in claim 7 wherein said retainer is welded to the fuel tank.

9. A fuel sealing assembly as set forth in claim 3 wherein said retainer is integrally formed with the fuel sender unit.

10. A fuel sealing assembly for sealing a fuel sender unit to a fuel tank, said fuel sealing assembly comprising:
a retainer fixedly secured to the fuel tank, said retainer having a peripheral edge, said retainer including a plurality of retaining lugs extending out from said peripheral edge; and
a cover plate positionable over said retainer and the fuel sender unit for securing the fuel sender unit to said retainer, said cover plate defining a plurality of slots and a detent, wherein each of said plurality of slots receives one of said plurality of retaining lugs therein locking the cover plate over said retainer.

11. A fuel sealing assembly as set forth in claim 10 including a seal member positioned between said retainer ring and the fuel sender unit.

12. A fuel sealing assembly as set forth in claim 11 including a locking finger disposed on said peripheral edge of said retainer, said locking finger received by said detent of said cover plate.

13. A fuel sealing assembly as set forth in claim 12 wherein each of said plurality of retaining lugs engages said circumferential top surface of said cover plate preventing axial movement of said retainer and the fuel sender unit.

14. A fuel sealing assembly as set forth in claim 13 wherein said cover plate includes an outer edge and said detent extends into said outer edge.

15. A fuel sealing assembly as set forth in claim 14 wherein said peripheral edge of said retainer includes a tab extending radially out therefrom for aligning the fuel sender unit with said retainer.

16. A fuel sealing assembly as set forth in claim 15 wherein said retainer is welded to the fuel tank.

17. A fuel sealing assembly as set forth in claim 10 wherein said retainer is integrally formed with the fuel sender unit.

18. A method for manufacturing a fuel sealing assembly including a retainer having a locking finger and a plurality of retaining lugs and a cover plate, having a plurality of slots and a detent, for sealing a fuel sender unit with a fuel tank, the method comprising the steps of:
inserting a seal member between the retainer and the fuel sender unit;
aligning the cover plate with the retainer so that each of the plurality of slots of the cover plate is aligned with one of the plurality of retaining lugs of the retainer;
abutting the cover plate to the retainer so that each of the retaining lugs extends through one of the plurality of slots;
rotating the cover plate relative to the retainer and the fuel sender unit; and
locking the retainer to the cover plate.

19. A method for manufacturing a fuel sealing assembly as set forth in claim 18 wherein the step of locking includes the step of forcing the locking finger into the detent to lock.

20. A method for manufacturing a fuel sealing assembly as set forth in claim 19 further comprising the step of welding the retainer to the fuel tank.
